(19) United States
(12) Patent Application Publication
(10) Pub. No.: US 2015/0199421 A1
(43) Pub. Date: Jul. 16, 2015

(54) METHOD OF AVOIDING INTERNODE JOIN IN A DISTRIBUTED DATABASE STORED OVER MULTIPLE NODES FOR A LARGE-SCALE SOCIAL NETWORK SYSTEM

(71) Applicant: Korea Advanced Institute of Science and Technology, Daejeon (KR)

(72) Inventors: Kyu-Young Whang, Daejeon (KR); Jin-Ah PARK, Daejeon (KR); Tae-Seob YUN, Daejeon (KR); Ilyeop YI, Daejeon (KR)

(73) Assignee: Korea Advanced Institute of Science and Technology, Daejeon (KR)

(21) Appl. No.: 14/534,510

(22) Filed: Nov. 6, 2014

(30) Foreign Application Priority Data
Jan. 14, 2014 (KR) 10-2014-0004478
Jul. 28, 2014 (KR) 10-2014-0095590

(51) Int. Cl. G06F 17/30

(52) U.S. Cl. CPC G06F 17/30604; G06F 17/30498; G06F 17/3033

(57) ABSTRACT

Disclosed herein is a method of modeling consecutive 1:N relationships into consecutive identifying relationships in a database distributed over a multiple nodes and giving the primary key of the first 1-side relation of the consecutive 1:N relationships to remaining relations as the identifying key to avoid internode join. The method includes modeling entity sets participating in consecutive 1:N relationships into consecutive identifying relationships, and mapping the modeled consecutive identifying relationships and the entity sets to relations. The method also includes a method of storing tuples of relations potentially accessed together in the same node and a method of allocating a query to the node storing the tuples to be accessed together.

### CROSS-REFERENCES TO RELATED APPLICATION

This patent application claims the benefit of priority under 35 U.S.C. §119 from Korean Patent Application No. 10-2014-0004478 filed Jul. 28, 2014, the contents of which are incorporated herein by reference.

### BACKGROUND OF THE INVENTION

1. Field of the Invention

The present invention relates to a method of avoiding internode join in a distributed database. In particular, the present invention relates to a method of avoiding an operation of internode join that is a main cause of degradation of data processing performance in a database distributed over multiple nodes, wherein an example of the database distributed over the multiple nodes may be a database used in a large-scale social network system.

2. Description of the Related Art

A database uses multiple relations for storing data in the relational format. A relation is mapped from an entity set in the entity relationship (ER) data model or a relationship between entity sets. The entity set means a set of entities having the same type.

The relation consists of the attributes mapped from the entity set or from the relationship between the entity sets. An attribute means a property of the entity set or the relationship between the entity sets.

Firstly, in order to help understand on the technology of the present invention, a method mapping an entity set or a relationship between entity sets to a relation is briefly described.

An entity set is mapped to a relation, and all the attributes of the entity set are mapped to attributes of the relation. However, when a relationship between entity sets is mapped to a relation, mapping is done differently depending on the type of the relationship.

A 1:N relationship means a relationship where multiple (N) entities in one entity set may have the relationship to one entity in the other entity set. For example, where we have a user set and an article set written by the user, multiple articles may be written by one user.

Such a 1:N relationship is mapped by including the primary key (the user ID in the foregoing example) of the relation mapped from the 1-side entity set (the user set in the foregoing example) in the relation napped from the N-side entity set as a foreign key. For example, the user ID is included as a foreign key in the relation mapped from the article sets.

However, among 1:N relationships, a 1:N relationship may be exceptionally present between an entity set having a primary key and an entity set that does not have sufficient attributes to form a primary key. This 1:N relationship is called an identifying relationship.

Since, in an identifying relationship, N-side entities may exist only when an 1-side entity exists, the relationship may be mapped by including the primary key of the relation mapped from the 1-side entity set as a part of the primary key of the relation mapped from the N-side entity set.

Meanwhile, data related to different relations may be accessed together through an operation called join, which is a query processing scheme retrieving tuples of two different relations having specific values for the same attributes that are shared by the two relations.

FIG. 1 shows a conventional relation mapping method for a 1:N relationship.

We describe the conventional mapping method and the join operation (simply, “join”) using FIG. 1.

The upper part of FIG. 1 illustrates a database with entity sets 110, 120, and 130 and relationships 140 and 150. Here, the relationship 140 relating the entity sets (110, 120) and the relationship 2 150 relating entity sets (120, 130) are in 1:N relationships.

Now, two relations 160 and 170 are mapped from entity sets 110 and 120 of the relationship 1 140. Here, since the primary key 161 mapped from the 1-side entity set 110 is shared in the N-side entity set by mapping the relationship 1 140, related data (tuples having the same values for the shared attributes) from the two relations can be retrieved together through join on the shared attributes 161. If we extend the above example, related data between relations can be retrieved together through join for the shared attributes even in the case of relations connected through consecutive 1:N relationships such as the relations 160, 170, and 180, which are mapped from the entity sets 110, 120, and 130 connected through the relationships 140 and 150 as illustrated in FIG. 1. In FIG. 1, tuples related to the three relations (160, 170, 180) can be retrieved by performing consecutive joins of two relations 160 and 170 (napped from the entity sets 110 and 120) on the shared attribute 161 and two relations 170 and 180 (mapped from the entity sets 120 and 130) on the shared attribute 171. These consecutive joins is not limited in length.

Meanwhile, in the case where data are stored in the relational format in multiple nodes, tuples of the relations joined may be stored in different nodes since they are distributed over multiple nodes. In this case, internode join is necessary. The internode join is a query processing scheme when two relations joined are stored in different nodes. In FIG. 1, for example, when the tuples of the relation 1 160 and the relation 2 170 are stored in nodes 1 and 2 distributed by the attribute 1_1 161 and the relation 3 180 is stored in nodes 1 and 2 distributed by the attribute 3_1 181, tuples having the same value for an attribute 2_1 171 in relations 2 170 and 3 180 can be stored in different nodes (node 1 and node 2). Here, when the relations 2 and 3 are joined, internode join can occur.

Non-patent literature 1, “Using Semi-Joins to Solve Relational Queries, Journal of the ACM, Vol. 28 No. 1, pp. 25-40, Jan. 1981, Bernstein, P. and Chiu, D” described below presents a semi-join algorithm for processing the internode join, which is described briefly.
\textcircled{1} One of the relations to be joined R1 is projected on the join attribute \textcircled{2} The projected result is transmitted to the node where the other relation R2 resides, and then, joined with R2, and \textcircled{7} the internode join is completed by transmitting the joined result to the node where R1 resides and joining with R1.
   During such semi-join, data are transmitted airong the nodes via network. Therefore, as the volume of data transmitted via network increases in a large-scale system, efficiency of query processing will deteriorate since the join is completed only after all these transmissions are performed.

### SUMMARY OF THE INVENTION

Embodiments of the present invention are directed to providing a method for avoiding internode join due to a 1:N relationship in a database distributed over multiple nodes. For this, the method gives the primary key of the first 1-side relation to the remaining relations by storing in the same node the tuples of relations being possibly accessed together through a 1:N relationship, and, to do this, model consecutive 1:N relationships into consecutive identifying relationships. In addition, the invention provides a method of distributing the tuples of relations that are mapped by foregoing method to store in multiple nodes, and a method of allocating queries to these nodes.

Therefore, embodiments of the present invention includes a method of modeling consecutive 1:N relationships into consecutive identifying relationships in a database distributed over multiple nodes and giving the primary key of the first 1-side relation to remaining relations when mapping the modeled consecutive identifying relationships and the entity sets to relations.

The mapping to the relations includes mapping the entity sets to the relations and mapping the identifying relationships between the entity sets to the relations. The latter includes giving the primary key of the first 1-side relation in the consecutive 1:N identifying relationships to the remaining relations.

Embodiments of the present invention also includes a method of storing tuples of the relations mapped by the forgoing method into specific nodes. The method includes performing hashing the value of the identifying key (i.e., the attribute borrowed from the primary key of the first 1-side relation) and determining the node corresponding to the hashed result as the node storing the tuples having this identifying key value.

Embodiments of the present invention also includes a method of allocating a query to the node in which the relations mapped by the foregoing method are stored. The method includes performing hashing the value of the identifying key that is specified in the predicate (or the condition) of the query and allocating the query to the node corresponding to the hashed result.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a method of mapping entity sets having 1:N relationships to relations using a conventional mapping scheme;

FIG. 2 illustrates a method of modeling consecutive 1:N relationships into consecutive identifying relationships and giving the primary key of the first 1-side relation to the remaining relations according to the present invention;

FIG. 3 illustrates steps of modeling consecutive 1:N relationships into consecutive identifying relationships and giving the primary key of the first 1-side relation to the remaining relations according to the present invention;

FIG. 4 illustrates detailed steps of the operation 320 in FIG. 3;

FIG. 5 illustrates steps for node allocation of tuples of a relation and node allocation of a query;

FIG. 6 illustrates the method of storing tuples of each mapped relation to the nodes through modular hashing, which is an example hashing method;

FIG. 7 illustrates the method of allocating a query to the node where relevant tuples are stored through modular hashing, which is an example hashing method; and

FIG. 8 illustrates an example social network service database where the entity sets are connected in consecutive 1:N relationships.

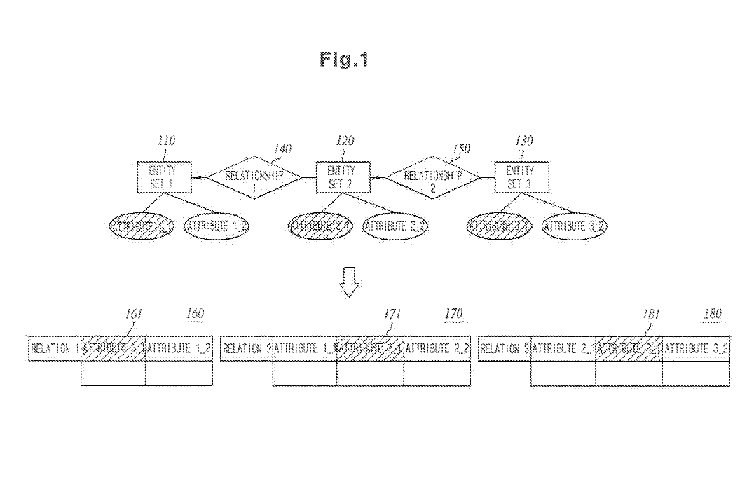

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding to the technical sprit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

A technical gist of the present invention is briefly described. Internode join occurs, since tuples to be joined may be stored in different nodes when related data (tuples having the same shared attribute value) of different relations are accessed together in a database distributed over multiple nodes.

However, when the number of tuples of relations joined increases, the amount of data transmitted among the nodes over the network increases and the query processing performance is degraded.

Accordingly, in order to avoid internode join in a database distributed over multiple nodes, it is necessary that tuples of relations being possibly accessed together through a relationship are stored in the same node. Once they are stored in the same node, a query can be allocated to a specific node and processed within the node.

Hereinafter, specific embodiments of the present invention will be described in detail with reference to the accompanying drawings.

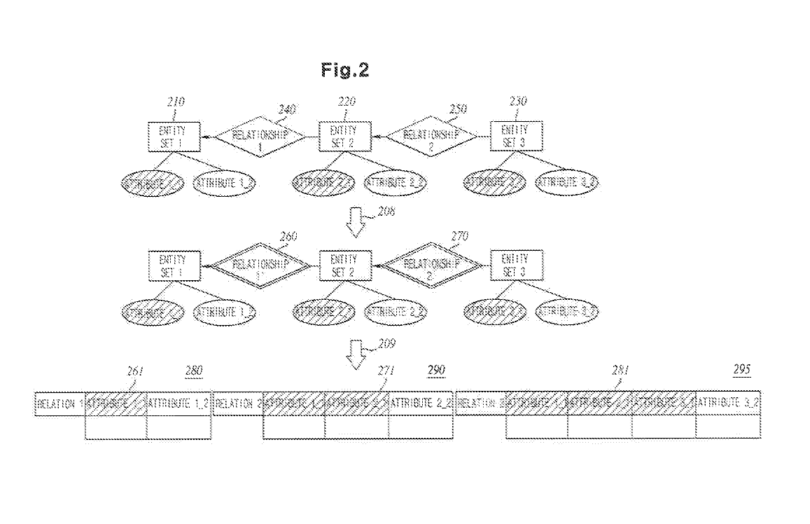

FIGS. 2, 3, and 4 illustrate a method of modeling consecutive 1:N relationships into consecutive identifying relationships and giving the primary key of the first 1-side relatron to the remaining relations, thereby avoiding internode join in a database distributed over multiple nodes.

First, in FIG. 2, the relationship 1 240 representing a 1:N relationship between the entity set 1 210 and the entity set 2 220 is converted into the identifying relationship 1′ 260, and the relationship 2 250 representing a 1:N relationship between the entity set 220 and the entity set 3 230 is converted into the relationship 2′ 270 representing an identifying relationship (operation 208).

Then, consecutive 1:N relationships converted into consecutive identifying relationships and entity sets participating in the corresponding relationships are mapped to relations (operation 209).

Description regarding the mapping of these entity sets to the relations is provided in detail.

First, mapping of entity sets is performed. In FIG. 2, the entity set 1 210 is mapped to the relation 1 280, the entity set 2 220 to the relation 2 290, and the entity set 230 to the relation 3 295. At this point, the attributes of each entity set are mapped to the attributes of the corresponding relation without a change.

Then, finally, mapping of relationships between entity sets is performed. According to the conventional mapping scheme for identifying relationships, the relationship 1′ 260 includes the attribute 1_1 261, which is the primary key of the relation 1 280 mapped from the entity set 1 210, as a part of the primary key of the relation 2 290 mapped from the entity set 2. Likewise, the relationship 2′ 270 includes the attribute 1_1 and the attribute 2_1 (a reference numeral 271 represented as shaded) as a part of the primary key of the relation 3 295, which is mapped from the entity set 2 230. Here, the attribute 1_1 included in each relation is called the identifying key.

In other words, the attribute 1_1 13, which the primary key of the relation mapped from the first 1-side entity set in consecutive 1:N relationships, is given to all the relations mapped from the entity sets participating in the consecutive 1:N relationships.

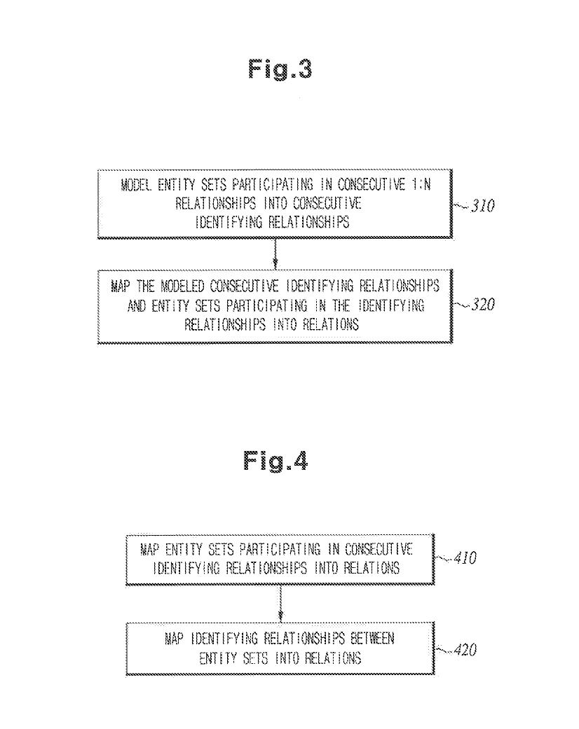

FIGS. 3 and 4 illustrate the methods described above.

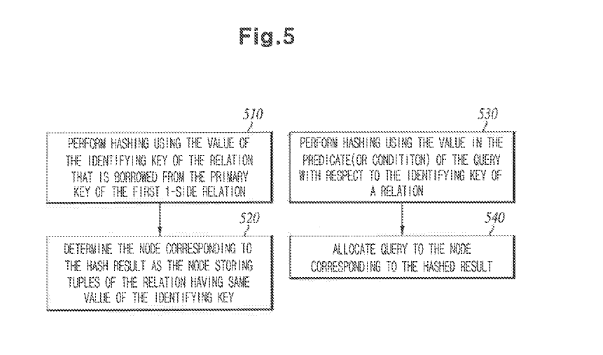

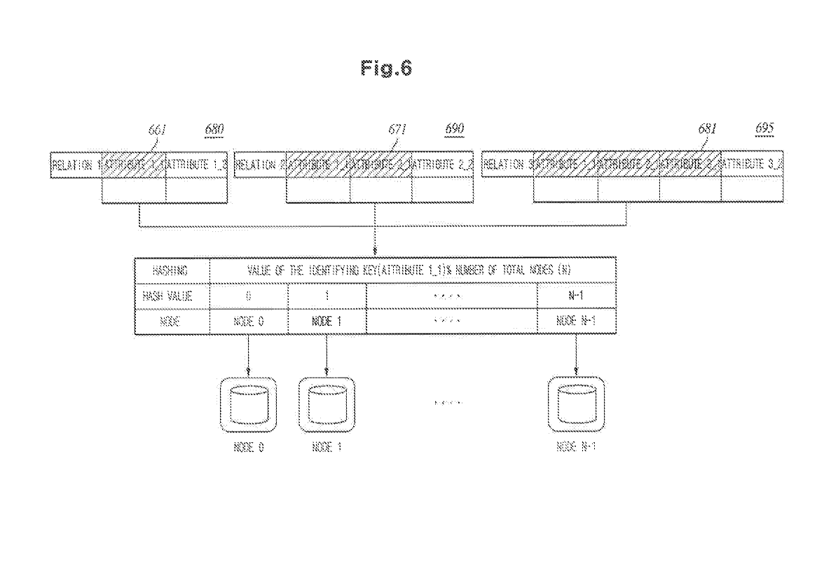

FIGS. 5 and 6 illustrate the method of storing tuples of relations in each node, when the primary key of the first 1-side relation is given to the remaining relations by modeling consecutive 1:N relationships into consecutive identifying relationships in a database distributed over multiple nodes.

In the method of determining the node to store tuples of the relations mapped from the entity sets participating in the consecutive 1:N relationships, firstly, hashing is performed (operation 510) with the value of the identifying key, and the node corresponding to the hash result is determined as the node to store the corresponding tuple (operation 520).

Although FIG. 6 illustrates an exemplary case where modular hashing is used, any hashing method that can distribute tuples to each node in a uniform manner can be used.

Accordingly, tuples having the same identifying key value from all the relations mapped from the entity sets participating in the consecutive 1:N relationships are stored in the same node.

Accordingly, since the tuples having the possibility of being accessed together through an identifying 1:N relationship among the tuples of the relations mapped from the entity sets participating in consecutive 1:N relationships, internode join does not occur when processing a join query that accesses tuples of the relations through identifying relationships.

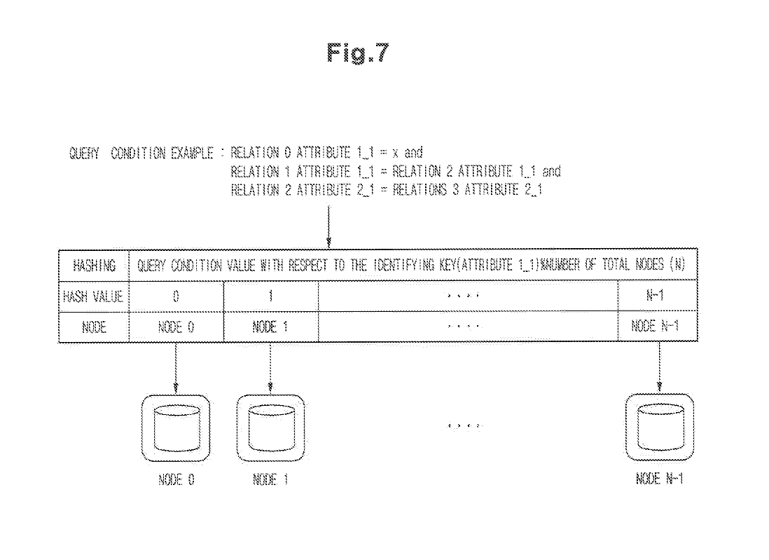

FIGS. 5 and 7 illustrate a method of allocating a join query that accesses tuples of multiple relations together through identifying relationships to a specific node where the tuples are stored, where the tuples of the relations mapped from the entity sets are stored in a node determined by hashing with the identifying key.

For tuples of relations mapped from the entity sets participating in the consecutive 1:N relationships, in the method of allocating a join query that accesses tuples of multiple relations together through a part of the consecutive 1:N relationships to a node, hashing is first performed with the value in the predicate (or the condition) of the query with respect to the identifying key of a relation, and the query is allocated (operation 540) to the node corresponding to the hash result. Similar to FIG. 6, FIG. 7 illustrates an example where modular hashing on the query condition value with respect to the identifying key is used to determinate the node to be allocated the query. Since a join query accessing tuples of multiple relations together is allocated to the specific node that store the tuples having the possibility of being accessed together through the node determination method in FIG. 6, internode join can be avoided.

The invention can also be embodied as computer readable codes on a computer readable recording medium. The computer readable recording medium is any data storage device that can store data which can be thereafter read by a computer system. Examples of the computer readable recording medium include a hard disk, read-only memory (RCM), random-access memory (RAM), CD-ROMs, magnetic tapes, floppy disks, and optical data storage devices.

The above-described method that gives the primary key of the first 1-side relation to the remaining relations by modeling consecutive 1:N relationships into consecutive identifying relationships in order to avoid internode join in a database distributed over multiple nodes, is advantageous as explained below.

First, query processing performance is improved by avoiding internode join due to 1:N relationships in a database distributed over multiple nodes. Since the primary key of the first 1-side relation is given to all the relations mapped from the entity sets participating in consecutive 1:N relationships modeled into consecutive identifying relationships, related tuples (i.e., those having the same shared attribute value) of the relations mapped from the entity sets participating in the consecutive 1:N relationships are stored in the same node. Accordingly, when tuples of relations are accessed through a part of consecutive 1:N relationships, a join query for processing this is allocated to the node where the those tuples are stored, and therefore, the join occurs only in a specific node. Since internode join, which causes performance degradation of query processing is avoided this way, query processing performance can be improved. In particular, when all the relations distributed over the multiple nodes are connected in consecutive 1:N relationships, the primary key of the first 1-side relation is given to all the relations as the identifying key and tuples of all these relations can be distributed and stored in the multiple node based on the identifying key.

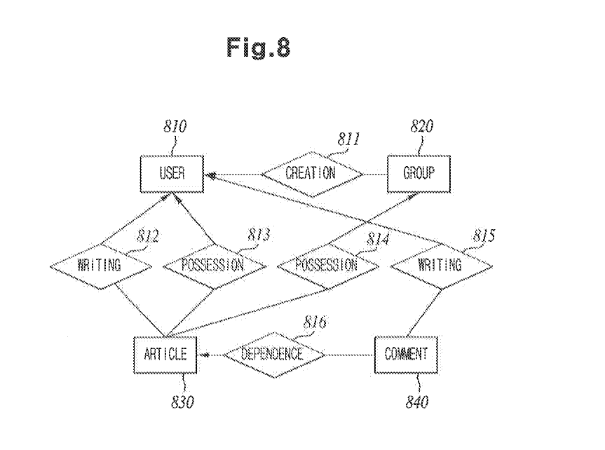

For example, in a social network system (SNS) configured with user, group, article, and comment entity sets illustrated in FIG. 8, all the entity sets are connected through consecutive 1:N relationships. Since a user 810 may create multiple groups 820 and the groups 820 are created by one user, the user entity set 810 and the group entity set 820 have a 1:N relationship 811. Similarly, since a user 810 or a group 820 can possess multiple articles 830 and the articles 830 can be possessed by one user 810 or one group 820, the user entity set 810 and the article entity set 830, have a 1:N relationship; so do the group entity set 820 and the article entity set 830. In addition, since an article 830 can have multiple comments 840 and the comments 840 belong to one article 830, the article entity set 830 and the comment entity set 840 have a 1:N relationship. In other words, all the relations are connected through consecutive 1:N relationships, and accordingly, all the relations are given the primary key of the user relation mapped from the user entity set 801, which is the first 1-side entity set in consecutive 1:N relationships. In this case, even when tuples of relations are accessed together through a certain 1:N relationship, internode join does not occur.

Second, it is simple and efficient to determine the node in which tuples of relations are to be stored. When the tuples of the relations napped from entity sets participating in the consecutive 1:N relationships are stored, the node to store the tuples can be determined through hashing with the value of the identifying key, which is the primary key of the first 1-side relation. For example, if modular hashing is employed, tuples are stored in the node corresponding to the result of the modular operation between the value of the identifying key and the total number of nodes. In this case, since no additional processing is required for determining the node in which tuples are to be stored besides hashing, the determination of the node for storing tuples is simple and efficient.

Third, it is simple and efficient to determine the node to which a query is to be allocated. In the case of a query involving the relations mapped from entity sets participating in consecutive 1:N relationships, the node to allocate the query can be determined through hashing with the value of the identifying key, which is specified in the predicate (or the condition) of the query. For example, if modular hashing is employed, the query is allocated to the node corresponding to the result of the modular operation between the query condition value with respect to the identifying key and the total number of nodes. In this case, since no additional processing is required for determining the node to allocate a query besides hashing, the determination of the node to allocate the query is simple and efficient.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method, which is implemented in a computer, of modeling consecutive 1:N relationships into consecutive identifying relationships in a database distributed over a multiple nodes and giving the primary key of the first 1-side relation to remaining relations as the identifying key to avoid internode join comprising:
modeling entity sets participating in consecutive 1:N relationships stored in the database into consecutive identifying relationships; and
mapping the modeled consecutive identifying relationships and the entity sets to relations.

2. The method as set forth in claim 1, wherein mapping to relations comprises,
mapping the entity sets to relations; and
napping the identifying relationships between the entity sets to relations, and
wherein the mapping of the identifying relationships to relations comprises giving the primary key of the first 1-side relation in the consecutive 1:N relationships to the remaining relations as the identifying key of each relation.

3. A method of storing tuples of a relation mapped by the method as set forth in claim 1 or claim 2 in a specific node, the method comprising:
performing hashing with the value of the identifying key in the tuple; and
determining the node corresponding to the hash result as the node to store the tuple of the relation.

4. A method of allocating a query to the node in which the tuples to be accessed together of the relations mapped by the method as set forth in claim 1 or claim 2 are stored, the method comprising:
performing hashing with the value of the identifying key specified in the predicate (or the condition) of the query; and
allocating the query to the node corresponding to the hash result.
